(19) United States
(12) Patent Application Publication
(10) Pub. No.: US 2016/0089285 A1
(43) Pub. Date: Mar. 31, 2016

(54) FOLDING DEVICE FOR POWER SCOOTERS

(71) Applicant: Ming-Chuan Cheng, Taichung City (TW)

(72) Inventor: Ming-Chuan Cheng, Taichung City (TW)

(21) Appl. No.: 14/501,042

(22) Filed: Sep. 30, 2014

(51) Int. Cl. A61G 5/08; A61G 5/04; B62K 5/007

(52) U.S. Cl. CPC A61G 5/08; B62K 5/007; A61G 5/045; A61G 2005/0833; A61G 2005/0866; A61G 2005/0883

(57) ABSTRACT

A folding device of a power scooter includes a base which includes a front portion and a rear portion. Two folding units are located on two sides of the base and pivotably connected between the front portion and the rear portion. The rear wheel unit is driven by a motor and moves toward the front wheel unit of the scooter to fold the front and rear portions.

### BACKGROUND OF THE INVENTION

1. Fields of the Invention

The present invention relates to a folding device, and more particularly, to a folding device for a power scooter.

2. Descriptions of Related Art

The conventional power scooters are used for helping disables to move conveniently by themselves. These conventional power scooters are designed for one or two persons to use and the scooters are driven by a motor and the users operate the handlebar to control the speed and directions that they want to access. However, these conventional power scooters are bulky and heavy, and occupy a certain space which may not be available for some of the users.

The present invention intends to provide a folding device for a power scooter so as to eliminate the shortcomings mentioned above.

### SUMMARY OF THE INVENTION

The present invention relates to a power scooter and comprises a base having a rear wheel unit located at the underside of the rear end thereof. A motor is connected to the base and drives the rear wheel unit. A front wheel unit is connected to the underside of the front end of the base. A seat unit is connected on the top of the rear end of the base. A steer rod is connected to the base and connected to the front wheel unit. Two folding units are located on two sides of the base to control the base to be horizontal or folded. Two L-shaped slides are respectively connected to the base and located close to the folding units. Each slide has a first section connected to the base, and a second section of each slide extends perpendicularly from the base and has a slot defined therethrough. Two support frames are pivotably connected between the seat unit and the base. Each support frame has two top connections and two bottom connections. The two top connections are connected to the underside of the seat unit. The two bottom connections are respectively connected to the base and the slot of the slide corresponding thereto. The motor is electrically connected to the steer rod. The two folding units are connected to the steer rod by wires.

When folding the power scooter, the folding units release the base from the horizontally pose, and the motor drives the rear wheel unit toward the front wheel unit. The folding units are operated to fold the base. The bottom connections of the support frames move along the slots to fold the seat unit.

Preferably, the two folding units define the base into a front portion and a rear portion, wherein the front portion has the front wheel unit connected thereto and the rear portion has the rear wheel unit connected thereto.

Preferably, the base has two axial tubes and two transverse tubes. The axial tubes and the transverse tube form a rectangular frame. Each of the front portion and the rear portion has one of the two transverse tubes. The two axial tubes are connected to the front portion and the rear portion. The two folding units are connected to the two axial tubes. One of the two bottom connections of each support frame is connected to the transverse tube corresponding thereto. The two slides are located on the two axial tubes and located close to the folding units.

Preferably, the steer rod has a U-shaped support unit connected to the lower end thereof. The support unit is located close to the transverse tube of the front portion. The support unit has a transverse plate and two end pieces are connected to two ends of the transverse plate. Two passive tubes each have the first end connected to the transverse tube, and the second end of each of the passive tubes contacts the conjunction portion of the transverse plate and the end piece. The second end of each of the passive tube has an aperture which is located corresponding to the end piece. Two locking members extend through the end pieces and are inserted into the apertures of the two passive tubes. When the two locking members are removed from the apertures of the passive tubes, the steer rod is folded toward the base.

Preferably, each of the folding units defines the axial tube corresponding thereto into a front section and a rear section. Each folding unit has a female member, a male member and a positioning member. The female member is mounted to the rear section. The male member is connected to the front section and located corresponding to the female member. The female member has two separated lugs. The male member has a rounded member located between the two lugs. A bolt extends through the two lugs and the rounded member. The positioning member is a U-shaped member and connected to one end of the rear section. The positioning member is pivotable relative to the rear section and covers a connection area between the male member and the female member.

Preferably, the positioning member is pivotably connected to one end of the female member. A first protrusion, a second protrusion and a third protrusion extend from one side of the positioning member. The third protrusion has a hole. The female member has a notch in which a spring which is compressed by the first protrusion when the positioning member is mounted to the female member. The male member has a first recess and a second recess. The second protrusion and the third protrusion are located corresponding to the first and second recesses. A locking unit is received in the recessed area in the inside of the second recess. The locking unit is connected to the steer rod by wires and is retractably inserted into the hole of the third protrusion to position the positioning member.

Preferably, the locking unit has a tongue, a control bar and a shaft. The tongue is located at the connection portion between the male member and the front section. The first end of the tongue normally protrudes beyond the inside of the second recess. The control bar has the first end thereof fixed to the tongue and the second end of the control bar is connected to the rear section. The shaft has the first end thereof extending through one side of the male member and connected to the tongue. The second end of the shaft extends beyond the male member and is connected to the steer rod by wires. A spring is mounted to the control bar and biased between the second end of the tongue and the rear section. The steer rod controls the movement of the shaft, and the shaft moves the tongue and the control bar, and compresses the spring mounted to the control bar.

Preferably, a leg unit is located between two front wheels of the front wheel unit and has two first portions and two second portions. A transverse shaft is connected between two first ends of the two first portions. The two second portions are connected to two second ends of the two first portions. Each second portion has a connection section connected to the first portion, a multiple-bent-portions contact section and a transverse bar which is connected between the connection section and the contact section. The contact section extends to the direction opposite to that of the first portion. A step rod extends from each of the second portion and is located away from the transverse bar. The leg unit is pivotable relative to the front wheel unit. The contact section of each of the second portions and the transverse shaft contact against the floor to raise the front wheel unit.

Preferably, a retractable rod is connected to one side of the seat and pulled away from the seat when the base is in the folded status. Two rollers are connected to two sides of the rear wheel unit and the base is moved by the rollers when pulling the retractable rod.

The primary object of the present invention is to provide a power scooter wherein the folding action can be done by operating the motor to drive the rear wheel unit toward the front wheel unit to fold the base of the scooter.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the power scooter of the present invention;

FIG. 2 is a perspective view to show the base of the power scooter of the present invention;

FIG. 3 is a side view to show the power scooter of the present invention;

FIG. 4 is a side cross sectional view of the power scooter of the present invention;

FIG. 5 is an enlarged view to show the folding unit connected between the front portion and the rear portion of the power scooter of the present invention;

FIG. 6 shows the front wheel unit of the power scooter of the present invention;

FIG. 7 shows the locking members and the leg unit on the front wheel unit of the power scooter of the present invention;

FIG. 8 shows that the positioning member is pivoted upward before folding the base of the power scooter of the present invention;

FIG. 9 is an enlarged view to show the portion that the positioning member is pivoted upward relative to the folding unit of the power scooter of the present invention;

FIG. 10 shows that the base of the power scooter begins to be folded;

FIG. 11 is a cross sectional view to that the status in FIG. 10;

FIG. 12 is an enlarged view to show the action of the folding unit of the power scooter of the present invention when the base is folded;

FIG. 13 is a perspective view to show that the power scooter is completely folded;

FIG. 14 is a side view to show that the power scooter is completely folded;

FIG. 15 is a cross sectional view to show the status in FIG. 14;

FIG. 16 is a cross sectional view to show the action of the folding unit in FIG. 15, and

FIG. 17 shows that the folded power scooter is pulled.

### DETAILED DESCRIPTION OF THE PREFERRED EMBODIMENT

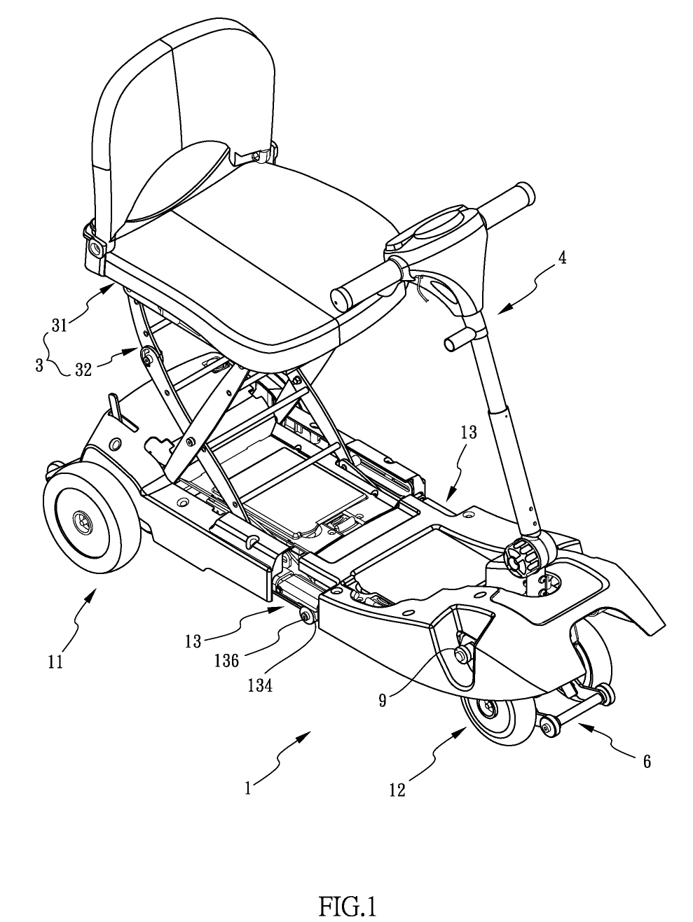

Referring to FIGS. 1 to 7, the power scooter of the present invention comprises a base 1 having a rear wheel unit 11 located at the underside of the rear end thereof. A motor 2 is connected to the base 1 and drives the rear wheel unit 11. A front wheel unit 12 is connected to the underside of the front end of the base 1. A seat unit 3 is connected on the top of the rear end of the base 1. A steer rod 4 is connected to the base 1 and connected to the front wheel unit 12. Two folding units 13 are located on two sides of the base 1 to control the base 1 to be horizontal or folded. Two L-shaped slides 14 are respectively connected to the base 1 and located close to the folding units 13. Each slide 14 has a first section connected to the base 1, and a second section of each slide 14 extends perpendicularly from the base 1 and has a slot 141 defined therethrough. Two X-shaped support frames 32 are pivotably connected between the seat unit 31 and the base 1. Each support frame 32 has two top connections 321 and two bottom connections 322. The two top connections 321 are connected to the underside of the seat unit 31. The two bottom connections 322 are respectively connected to the base 1 and the slot 141 of the slide 14 corresponding thereto. The motor 2 is electrically connected to the steer rod 4. The two folding units 13 are connected to the steer rod 4 by wires. The user controls the folding action of the base 1 by operating the steer rod 4.

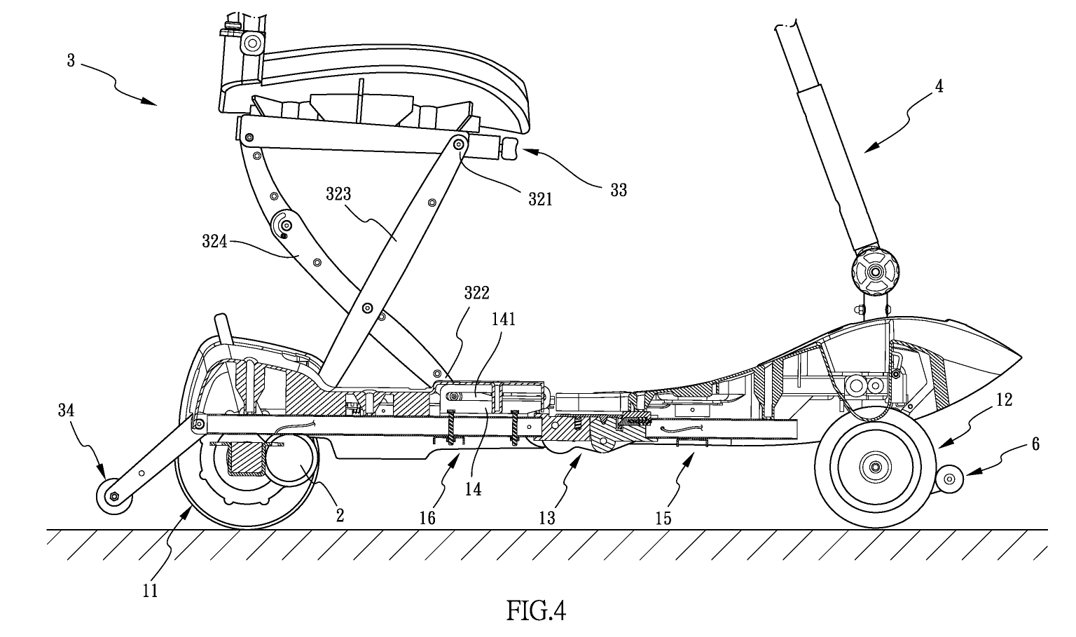

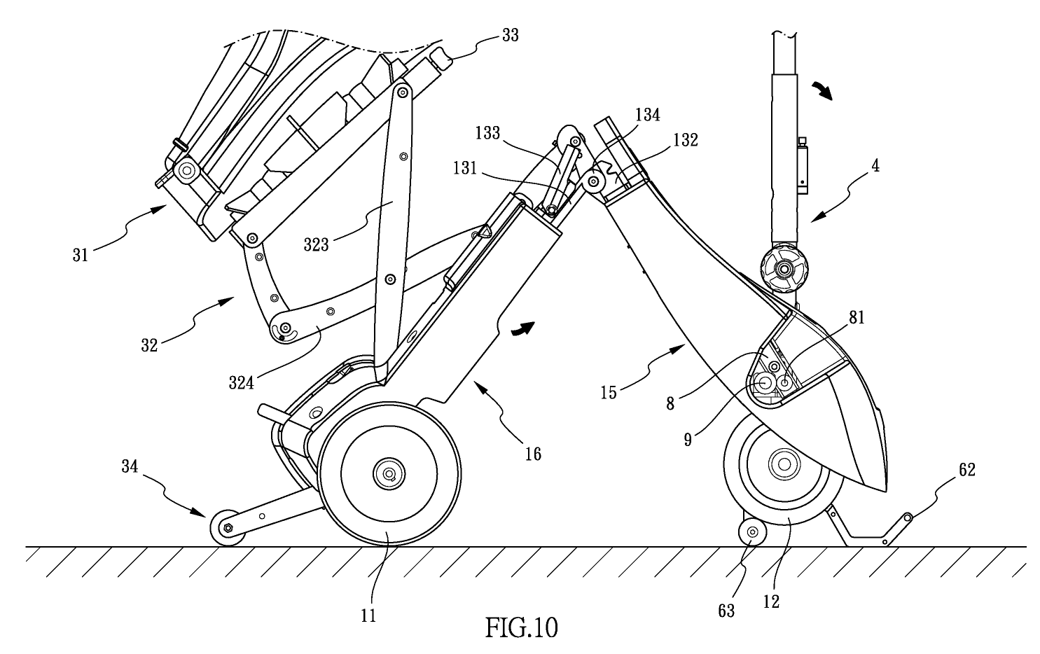

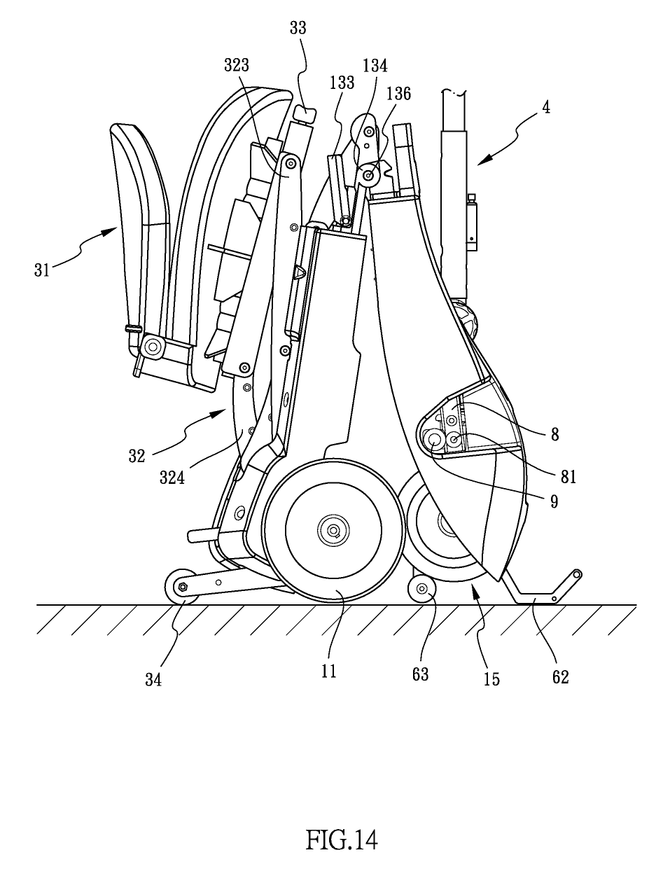

When folding the power scooter, the folding units 13 release the base 1 from the horizontally pose, and the motor 2 drives the rear wheel unit 11 toward the front wheel unit 12. The folding units 13 are operated to fold the base 1. The seat unit 3 is also folded toward the base 1 by moving the bottom connections 322 of the support frames 32 along the slots 141 to fold the seat unit 3. Therefore, the user can easily fold the power scooter as shown in FIGS. 4, 5, 10 and 14.

As shown in FIGS. 1, 2, 6 and 14, the two folding units 13 define the base 1 into a front portion 15 and a rear portion 16, wherein the front portion 15 has the front wheel unit 12 and the rear portion 16 has the rear wheel unit 11. The base 1 has two axial tubes 17 and two transverse tubes 18. The axial tubes 17 and the transverse tube 18 form a rectangular frame. The axial tubes 17 and the transverse tube 18 are located at the underside of the base 1 and covered by a casing. Each of the front portion 15 and the rear portion 16 has one of the two transverse tubes 18. The two axial tubes 17 are connected to the front portion 15 and the rear portion 16. The two folding units 13 are connected to the two axial tubes 17. One of the two bottom connections 322 of each support frame 32 is connected to the transverse tube 18 corresponding thereto. The two slides 14 are located on the two axial tubes 17 and located close to the folding units 13.

Each of the folding units 13 defines the axial tube 17 corresponding thereto into a front section 171 and a rear section 172. Each folding unit 13 has a female 131 member 131, a male member 132 and a positioning member 133. The female member 131 is mounted to the rear section 172. The male member 132 is connected to the front section 171 and located corresponding to the female member 131. The female member 131 has two separated lugs 134. The male member 132 has a rounded member 135 located between the two lugs 134. A bolt 136 extends through the two lugs 134 and the rounded member 135, so that the axial tubes 17 can be folded and overlapped to each other. The positioning member 133 is a U-shaped member and connected to one end of the rear section 172. The positioning member 133 is pivotable relative to the rear section 172 and covers a connection area between the male member 132 and the female member 131. The positioning members 133 are used to make the base 1 to be horizontal and prevents the folding units 3 from being folded unexpectedly.

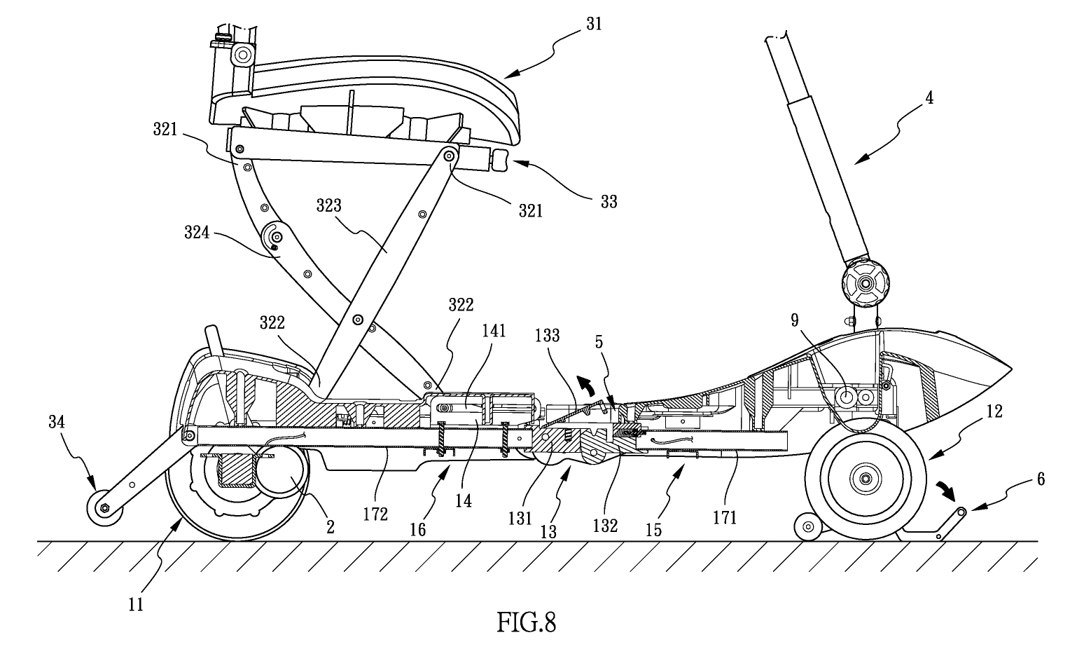

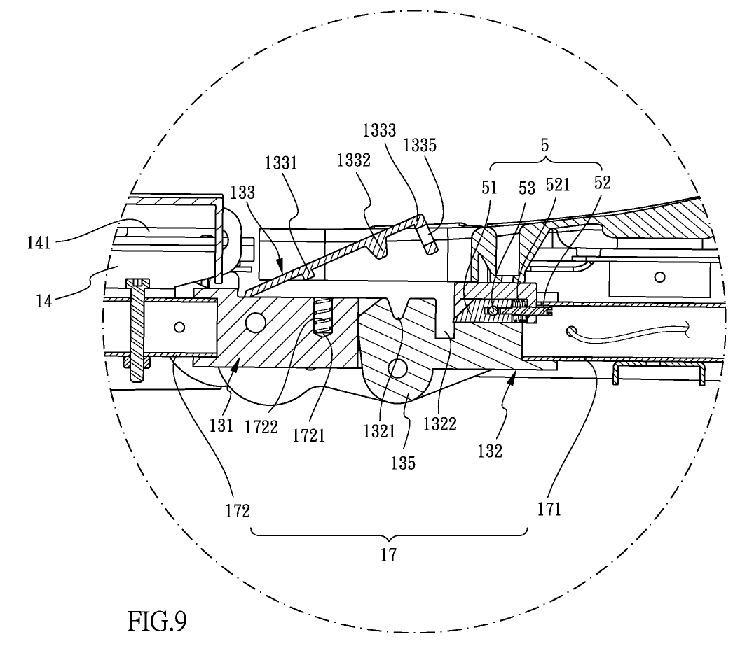

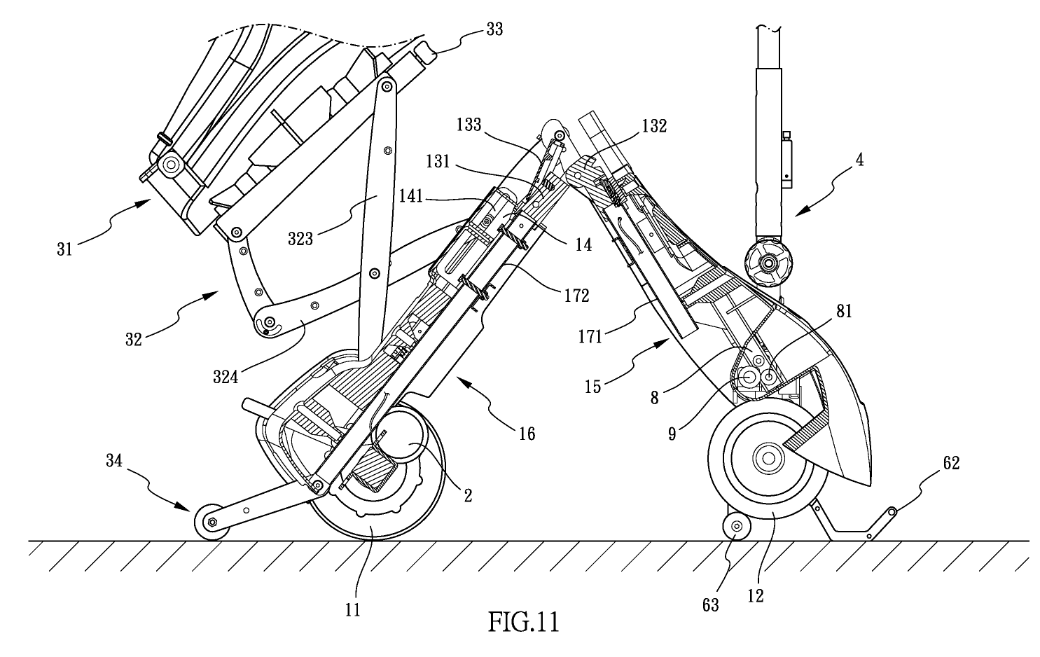

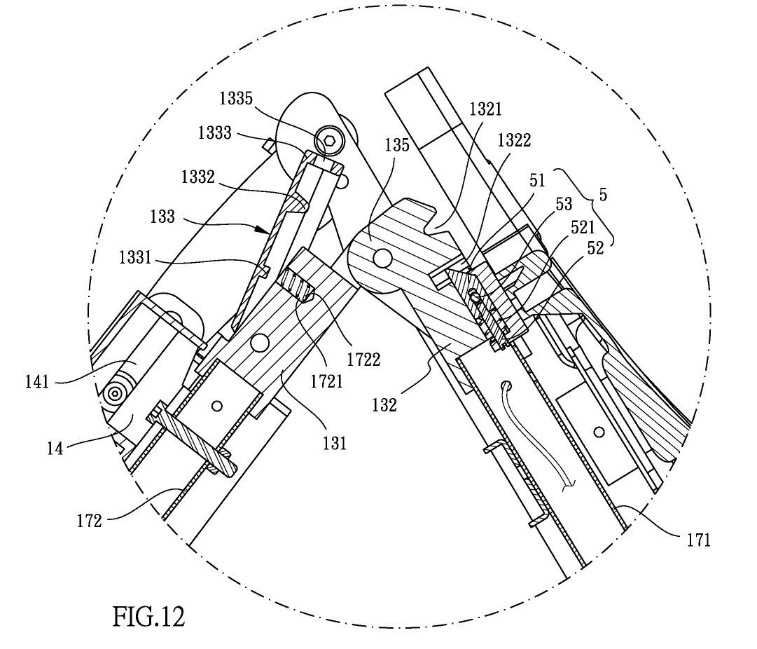

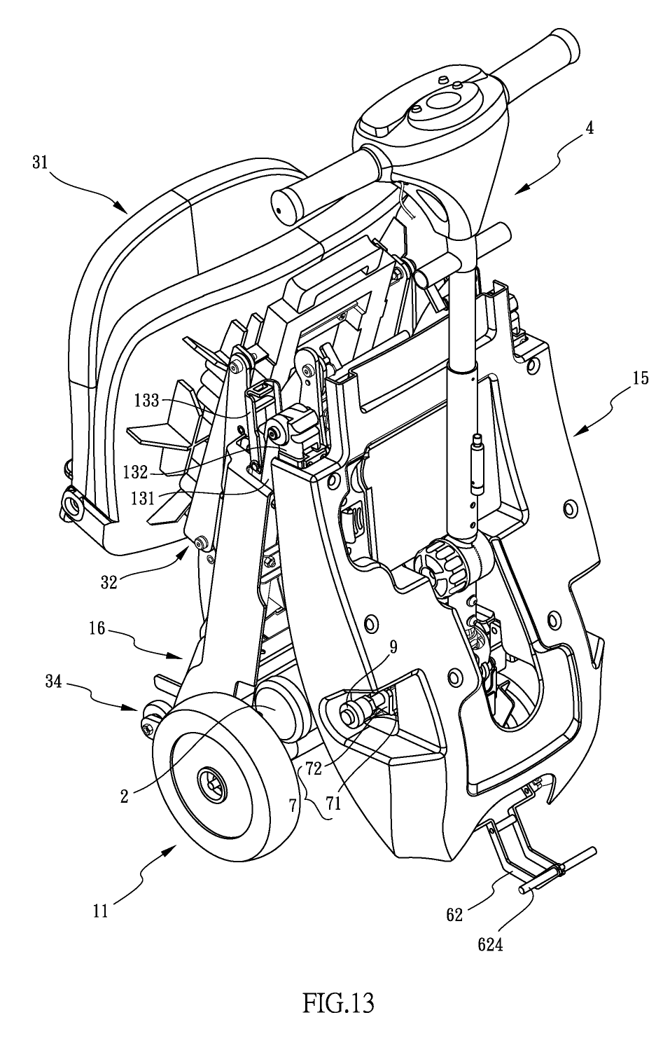

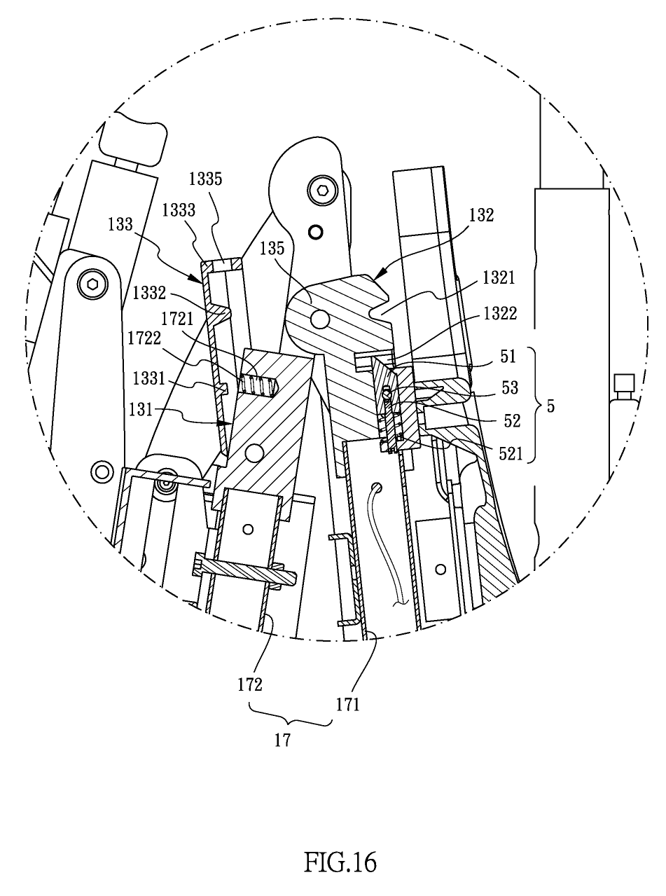

As shown in FIGS. 4, 8 and 11, the positioning member 133 is pivotably connected to one end of the female member 131. A first protrusion 1331, a second protrusion 1332 and a third protrusion 1333 extend from one side of the positioning member 133. The third protrusion 1333 has a hole 1335. The female member 131 has a notch 1721 in which a spring 1722 which is compressed by the first protrusion 1331 when the positioning member 133 is mounted to the female member 131. The male member 132 has a first recess 1321 and a second recess 1322. The second protrusion 1332 and the third protrusion 1333 are located corresponding to the first and second recesses 1321, 1322. A locking unit 5 is received in the recessed area in the inside of the second recess 1322. The locking unit 5 is connected to the steer rod 4 by wires and is retractably inserted into the hole 1335 of the third protrusion 1333 to position the positioning member 133. When the base 1 is transformed from the folded status into the horizontal status, the positioning member 133 is pivoted downward to insert the first, second and third protrusions 1331, 1332, 1333 into the notch 1721, the first recess 1321 and the second recess 1322. The first protrusion 1331 compresses the spring 1722 to store the energy which is used to pivot the positioning member 133 upward for the folding action next time. The third protrusion 1333 can be pushed toward the of the locking unit 5 in the second recess 1322 to let the locking unit 5 insert into the hole 1335 to position the base 1 at the horizontal status as shown in FIGS. 1, 5, 9, 12, 13, 16.

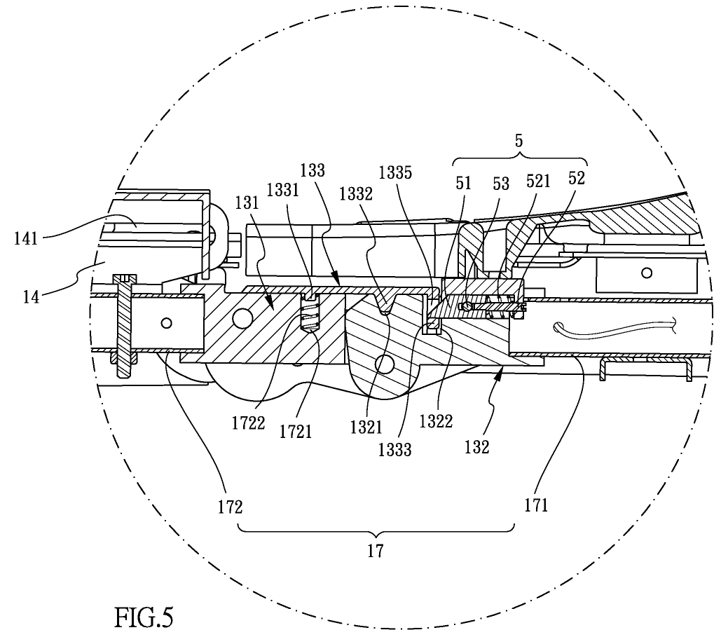

As shown in FIGS. 5, 9 and 12, the locking unit 5 has a tongue 51, a control bar 52 and a shaft 53. The tongue 51 is located at the connection portion between the male member 132 and the front section 171. The first end of the tongue 51 normally protrudes beyond the inside of the second recess 1322. The control bar 52 has the first end thereof fixed to the tongue 51 and the second end of the control bar 52 is connected to the rear section 172. The shaft 53 has the first end thereof extending through one side of the male member 132 and connected to the tongue 51. The second end of the shaft 53 extends beyond the male member 132 and is connected to the steer rod 4 by wires. A spring 521 is mounted to the control bar 52 and biased between the second end of the tongue 51 and the rear section 172. The steer rod 4 controls the movement of the shaft 53, and the shaft 53 moves the tongue 51 and the control bar 52, and compresses the spring 521 mounted to the control bar 52. When folding the base 1, the steer rod 4 controls the positioning member 133 to release the connection between the rear portion 16 and the front portion 15 by pulling the shaft 53 via the wires, the shaft 53 drives the tongue 51 and the control bar 52 to move backward and compresses the spring 1722. The tongue 51 is removed from the hole 1335 of the third protrusion 133. The energy stored in the spring 1722 pops the positioning member 133 upward, the third protrusion 1333 is then removed from the second recess 1322. The user then activates the motor 2 by operating the steer rod 4 to pivot the rear portion toward the front portion 15 to fold the base 1.

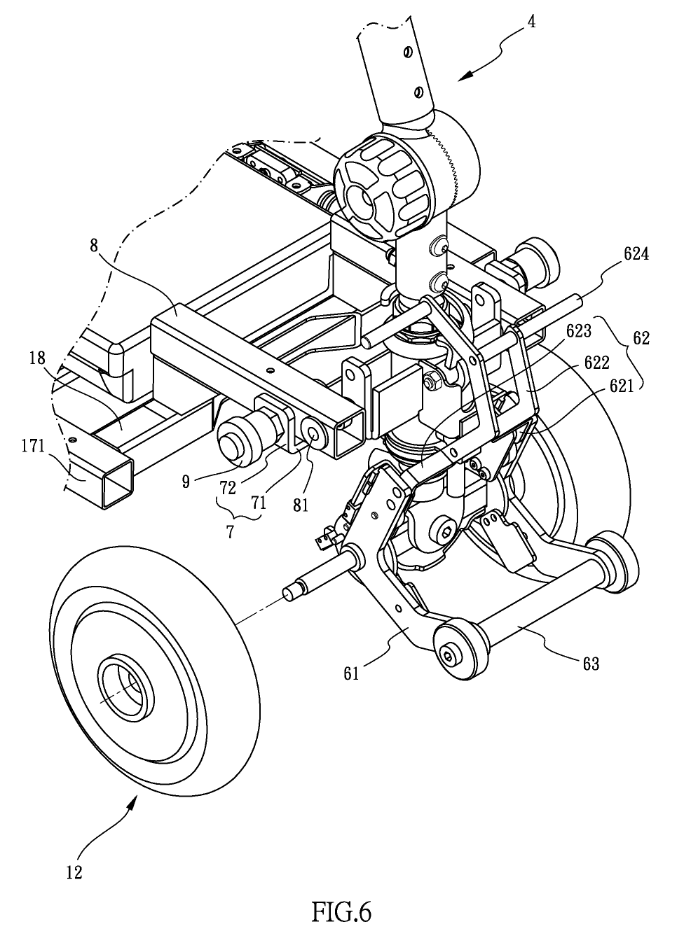

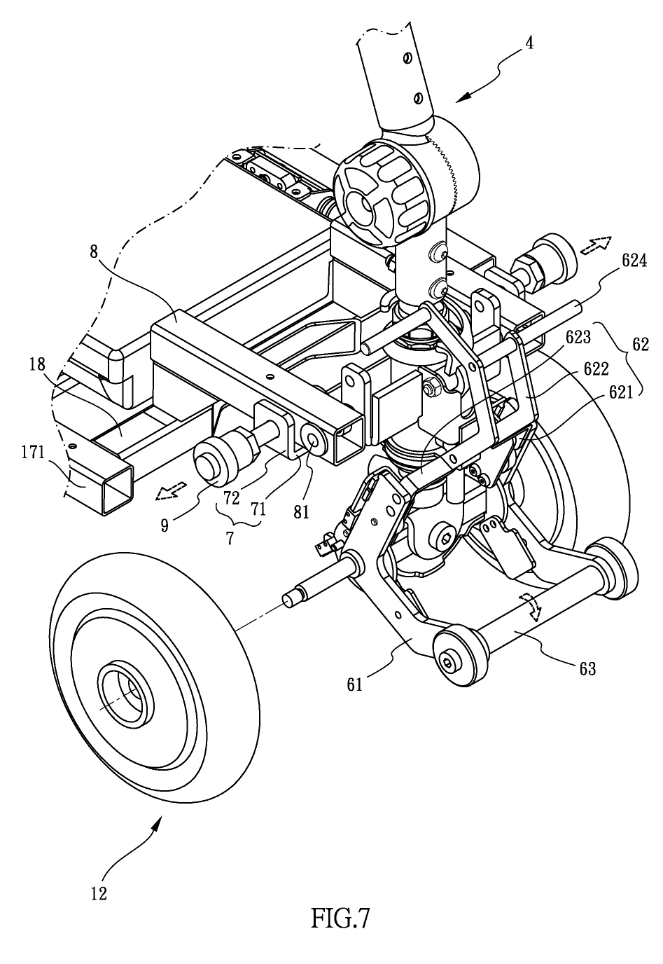

In order to secure the front portion 15 to ensure that the rear portion 16 is steadily folded toward the front portion 15, a leg unit 6 is located between two front wheels of the front wheel unit 12 and has two first portions 61 and two second portions 62. A transverse shaft 63 is connected between two first ends of the two first portions 61. The two second portions 62 are connected to two second ends of the two first portions 61. Each second portion 62 has a connection section 621 connected to the first portion 61, a multiple-bent-portions contact section 622 and a transverse bar 623 which is connected between the connection section 621 and the contact section 622. The contact section 622 extends to the direction opposite to that of the first portion 61. A step rod 624 extends from each of the second portion 62 and is located away from the transverse bar 623. The leg unit 6 is pivotable relative to the front wheel unit 12. The contact section 622 of each of the second portions 62 and the transverse shaft 63 contact against the floor to raise the front wheel unit 12. In detail, before folding the base 1, the user steps the step rod 624 downward to allow the transverse shaft 63 to move toward the front portion 15 and the leg unit 6 is pivoted toward the front wheel unit 12. The second portions 62 then contact against the floor to raise the front wheel unit 12 so that the front portion 15 and the rear portion 16 are folded to each other as shown in FIGS. 6 and 7.

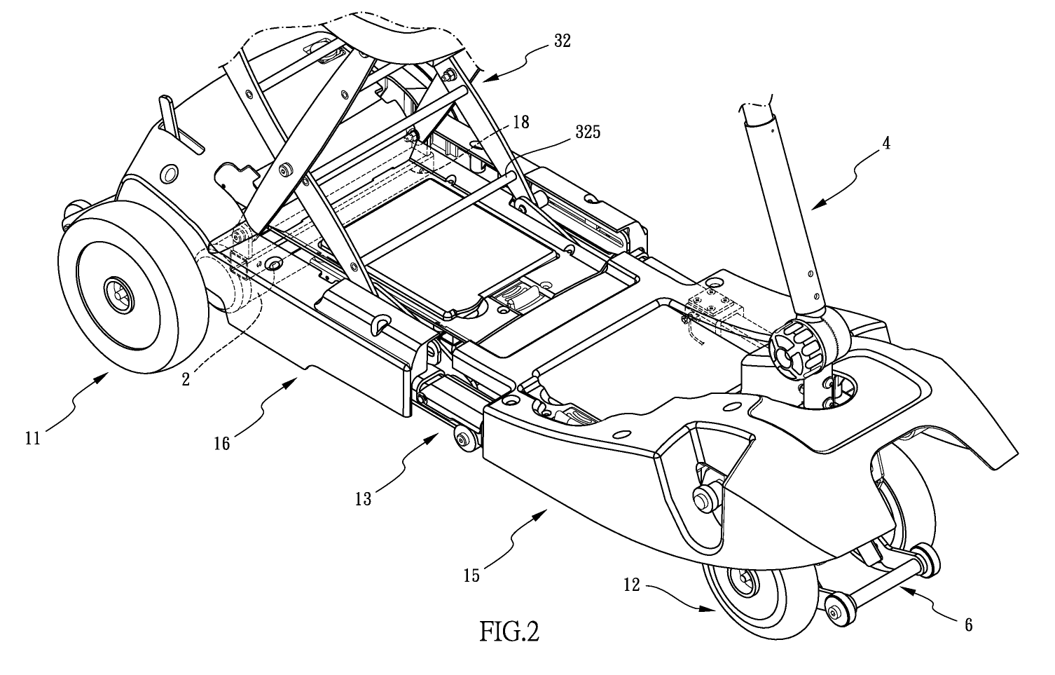

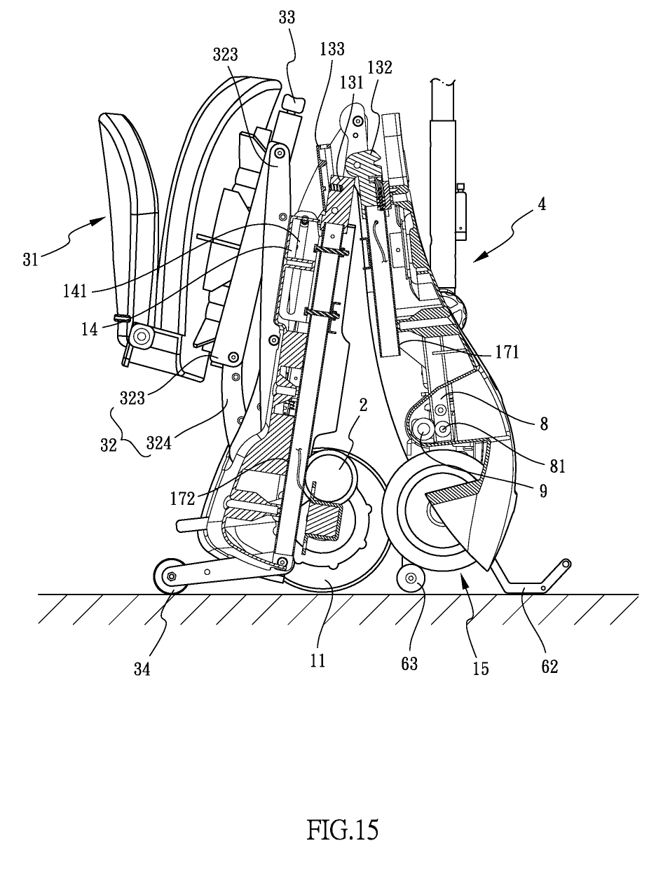

The folding of the seat unit 3 is made by the two X-shaped support frames 32. Each support frame 32 has a first link 323 and a second link 324 which is pivotably connected to the first link 323 at the middle portion thereof so as to form the X-shaped arrangement. The two support frames 32 are located parallel to each other at a distance, and multiple transverse links 325 are connected between the two support frames 32 so that the two support frames 32 are operated simultaneously. Each support frame 32 has the two top connections 321 connected to the underside of the seat 31 and the two bottom connections 322 are connected to the transverse tube 18 of the rear portion 16 and the slide 14 respectively. When the front portion 15 and the rear portion 16 are folded toward each other, the bottom connection 322 of each second link 324 moves along the slot 141 of the slide 14, and the first and second links 323, 324 are pivoted toward each other, therefore, the underside of the seat 31 is moved toward the rear portion 16 to finish the folding action as shown in FIGS. 2, 4, 11 and 15.

The steer rod 4 controls the direction that the power scooter moves, it also controls the operation of the motor 2 to fold the base 1. When the base 1 is folding, the steer rod 4 is also folded to avoid from being hit.

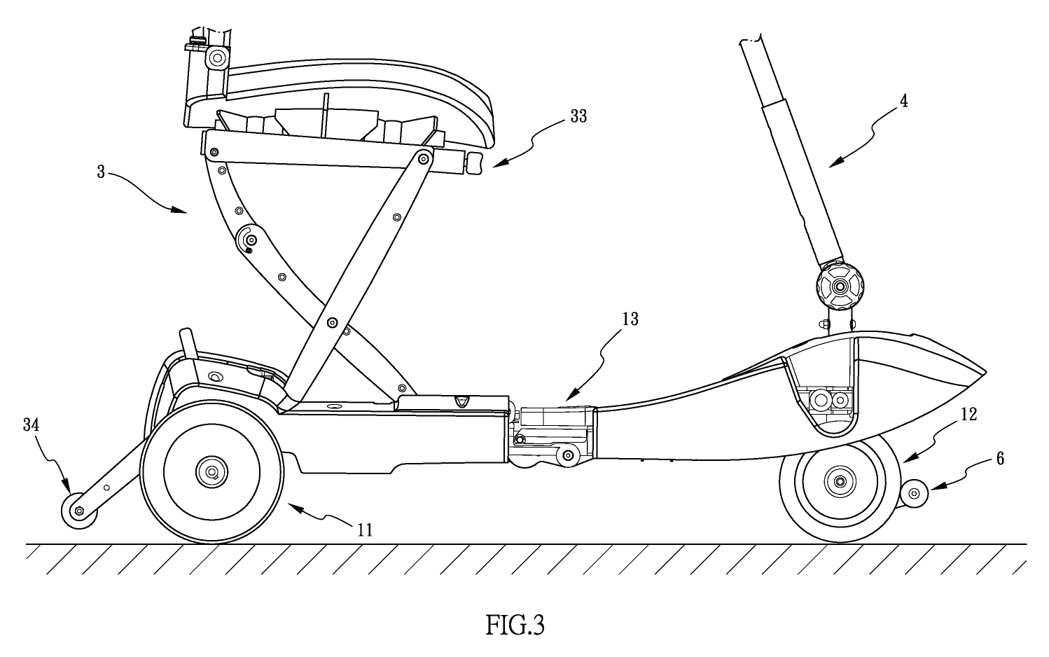

The steer rod 4 has a U-shaped support unit 7 connected to the lower end thereof. The support unit 7 is located close to the transverse tube 18 of the front portion 15. The support unit 7 has a transverse plate 71 and two end pieces 72 are connected to two ends of the transverse plate 71. Two passive tubes 8 each have the first end connected to the transverse tube 18, and the second end of each of the passive tubes 8 contacts the conjunction portion of the transverse plate 71 and the end piece 72. The second end of each of the passive tube 8 has an aperture 81 which is located corresponding to the end piece 72. Two locking members 9 extend through the end pieces 72 and are inserted into the apertures 81 of the two passive tubes 8. When the two locking members 9 are removed from the apertures 81 of the passive tubes 8, the steer rod 4 is operated back and forth to control the folding action as shown in FIGS. 6 and 7. The operation to the steer rod 4 controls the front portion 15 and the rear portion 16 begin to fold, and the motor 2 is activated by operation to the steer rod 4 to move the rear wheel unit 11 toward the front wheel unit 12 to complete the folding. The folded power scooter occupies less space as shown in FIGS. 3 to 5, and 8 to 16.

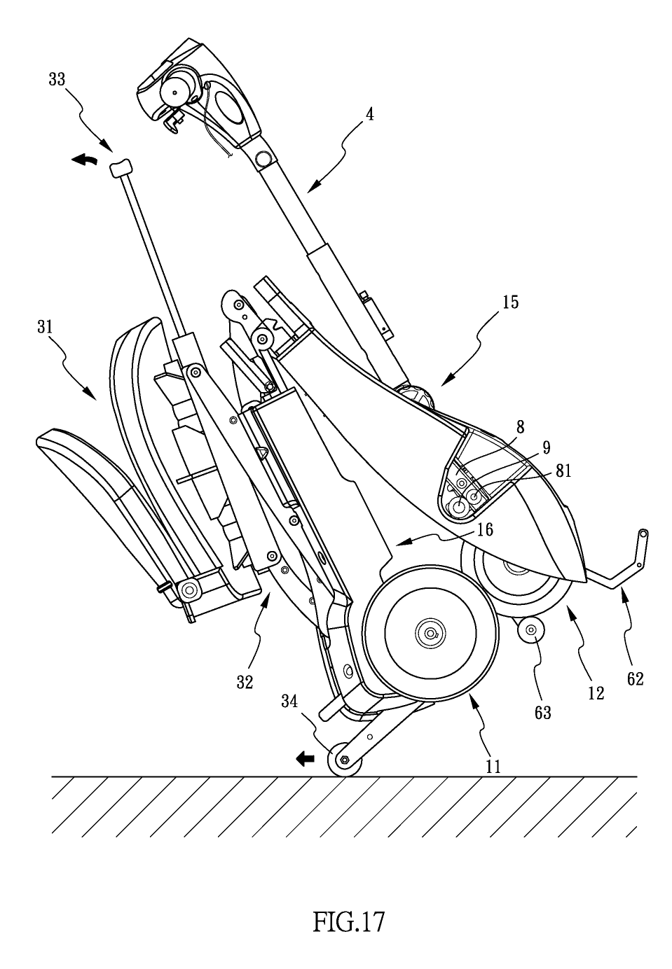

Preferably, a retractable rod 33 is connected to one side of the seat 31 and pulled away from the seat 31 when the base 1 is in the folded status. Two rollers 34 are connected to two sides of the rear wheel unit 11. By the retractable rod 33, the user can easily hold the retractable rod 33 and pulls the base 1 to move by the rollers 34 as shown in FIG. 17.

While we have shown and described the embodiment in accordance with the present invention, it should be clear to those skilled in the art that further embodiments may be made without departing from the scope of the present invention.

What is claimed is:

1. A power scooter comprising:
a base having a rear wheel unit located at an underside of a rear end thereof, a motor connected to the base and driving the rear wheel unit, a front wheel unit connected to the underside of a front end of the base, a seat unit connected on a top of the rear end of the base, a steer rod connected to the base and connected to the front wheel unit, two folding units located on two sides of the base to control the base to be horizontal or folded, two L-shaped slides respectively connected to the base and located close to the folding units, each slide having a first section connected to the base, a second section of each slide extending perpendicularly from the base and having a slot defined therethrough, two support frames pivotably connected between the seat unit and the base, each support frame having two top connections and two bottom connections, the two top connections connected to an underside of the seat unit, the two bottom connections respectively connected to the base and the slot of the slide corresponding thereto, the motor electrically connected to the steer rod, the two folding units connected to the steer rod by wires, and
when folding the power scooter, the folding units release the base from a horizontally pose, the motor drives the rear wheel unit toward the front wheel unit, the folding units are operated to fold the base, the bottom connections of the support frames move along the slots to fold the seat unit.

2. The power scooter as claimed in claim 1, wherein the two folding units define the base into a front portion and a rear portion, the front portion has the front wheel unit connected thereto and the rear portion has the rear wheel unit connected thereto.

3. The power scooter as claimed in claim 2, wherein the base has two axial tubes and two transverse tubes, the axial tubes and the transverse tube form a rectangular frame, each of the front portion and the rear portion has one of the two transverse tubes, the two axial tubes are connected to the front portion and the rear portion, the two folding units are connected to the two axial tubes, one of the two bottom connections of each support frame is connected to the transverse tube corresponding thereto, the two slides are located on the two axial tubes and located close to the folding units.

4. The power scooter as claimed in claim 3, wherein the steer rod has a U-shaped support unit connected to a lower end thereof, the support unit is located close to the transverse tube of the front portion, the support unit has a transverse plate and two end pieces are connected to two ends of the transverse plate, two passive tubes each have a first end connected to the transverse tube, a second end of each of the passive tubes contacts a conjunction portion of the transverse plate and the end piece, the second end of each of the passive tube has an aperture which is located corresponding to the end piece, two locking members extend through the end pieces and are inserted into the apertures of the two passive tubes, when the two locking members are removed from the apertures of the passive tubes, the steer rod is folded toward the base.

5. The power scooter as claimed in claim 1, wherein each of the folding units defines the axial tube corresponding thereto into a front section and a rear section, each folding unit has a female member, a male member and a positioning member, the female member is mounted to the rear section, the male member is connected to the front section and located corresponding to the female member, the female member has two separated lugs, the male member has a rounded member located between the two lugs, a bolt extends through the two lugs and the rounded member, the positioning member is a U-shaped member and connected to one end of the rear section, the positioning member is pivotable relative to the rear section and covers a connection area between the male member and the female member.

6. The power scooter as claimed in claim 5, wherein the positioning member is pivotably connected to one end of the female member, a first protrusion, a second protrusion and a third protrusion extend from one side of the positioning member, the third protrusion has a hole, the female member has a notch in which a spring which is compressed by the first protrusion when the positioning member is mounted to the female member, the male member has a first recess and a second recess, the second protrusion and the third protrusion are located corresponding to the first and second recesses, a locking unit is received in a recessed area in an inside of the second recess, the locking unit is connected to the steer rod by wires and is retractably inserted into the hole of the third protrusion to position the positioning member.

7. The power scooter as claimed in claim 6, wherein the locking unit has a tongue, a control bar and a shaft, the tongue is located at a connection portion between the male member and the front section, a first end of the tongue normally protrudes beyond the inside of the second recess, the control bar has a first end thereof fixed to the tongue and a second end of the control bar is connected to the rear section, the shaft has a first end thereof extending through a side of the male member and connected to the tongue, a second end of the shaft extends beyond the male member and is connected to the steer rod by wires, a spring is mounted to the control bar and biased between a second end of the tongue and the rear section, the steer rod controls a movement of the shaft, the shaft moves the tongue and the control bar, and compresses the spring mounted to the control bar.

8. The power scooter as claimed in claim 1, wherein a leg unit is located between two front wheels of the front wheel unit and has two first portions and two second portions, a transverse shaft is connected between two first ends of the two first portions, the two second portions are connected to two second ends of the two first portions, each second portion has a connection section connected to the first portion, a multiple-bent-portions contact section and a transverse bar which is connected between the connection section and the contact section, the contact section extends to a direction opposite to that of the first portion, a step rod extends from each of the second portion and is located away from the transverse bar, the leg unit is pivotable relative to the front wheel unit, the contact section of each of the second portions and the transverse shaft contact against a floor to raise the front wheel unit.

9. The power scooter as claimed in claim 1, wherein a retractable rod is connected to a side of the seat and pulled away from the seat when the base is in folded status, two rollers are connected to two sides of the rear wheel unit and the base is moved by the rollers when pulling the retractable rod.
